(19) United States
(12) Patent Application Publication
(10) Pub. No.: US 2022/0332236 A1
(43) Pub. Date: Oct. 20, 2022

(54) ENERGY-DISSIPATIVE PNEUMATIC CUSHIONING SYSTEM

(71) Applicant: MIS.CARBONART PTY LTD, Applecross (AU)

(72) Inventors: Alexander VINCAN, Mosman Park (AU); Yue SUN, Thornlie (AU); Gary Charles STRICKLAND, Kalamunda (AU)

(73) Assignee: MIS.CARBONART PTY LTD, Applecross (AU)

(21) Appl. No.: 17/641,105

(22) PCT Filed: Jul. 24, 2020
(86) PCT No.: PCT/AU2020/050758

§ 371 Date: Mar. 8, 2022

(30) Foreign Application Priority Data
Jul. 24, 2019 (AU) 2019902625

(51) Int. Cl. B60P 1/04; B60P 1/28

(52) U.S. Cl. CPC B60P 1/045; B60P 1/283

(57) ABSTRACT

An energy-dissipative pneumatic cushioning system for cushioning heavy loads includes (i) one or more support members that extend beneath at least a portion of at least one pneumatic cushioning element and (ii) at least one connector assembly that communicatively couple the at least one pneumatic cushioning element to a gas supply unit and optionally at least one gas reservoir. The at least one gas reservoir is capable of accepting at least a portion of gas from the at least one pneumatic cushioning element under a force of a load. The at least one connector assembly is further operable to allow a return of at least a portion of the gas to the at least one pneumatic cushioning element upon reduction of at least a portion of the force of the load.

PRIORITY CLAIM AND CROSS-REFERENCE TO RELATED APPLICATIONS

This application is a National Phase of PCT/AU2020/050758 filed Jul. 24, 2020, which claims benefit of and priority to Australia, Provisional Patent Application AUSN 2019902625 filed Jul. 24, 2020, titled ENERGY-DISSIPATIVE PNEUMATIC CUSHIONING SYSTEM, and is hereby incorporated by reference in its entirety, to the extent it is not inconsistent herewith.

This application incorporates by reference in its entirety, to the extent it is not inconsistent herewith, Australia Provisional Patent Application AUSN 2019902623 filed Jul. 24, 2020, titled LIGHTWEIGHT TRAY WITH PNEUMATIC CUSHIONING SYSTEM, Australia Provisional Patent Application AUSN 2019902624 filed Jul. 24, 2020, titled METHOD FOR CREATING AN ADHESIVE BOND USING AN ELASTOMERIC MATERIAL, and Australia Provisional Patent Application AUSN 2019902628 filed Jul. 24, 2020, titled METHOD FOR APPLYING A PROTECTIVE COATING TO A HAUL TRUCK TRAY.

### TECHNICAL FIELD

The embodiments herein generally relate to a pneumatic cushioning system, and more particularly to an energy-dissipative pneumatic cushioning system for cushioning heavy loads, such as for passive and active airbag preparation and/or deployment in a haul truck.

### BACKGROUND

The inventors of the inventions disclosed and claimed herein have recognized novel technical problems relating to haul truck component design, and have promulgated novel technical solutions to those problems, including improved haul truck tray design, improved tray support infrastructure, and improved cushioning elements to better support a tray. These improvements provide many benefits, including reduced overall truck weight, increased vehicle fuel efficiency, improved load capacity, reduced wear and tear, and better operational safety.

### SUMMARY

In view of the foregoing, embodiments herein provide an energy-dissipative pneumatic cushioning system for managing heavy loads, which are often measured in tons, as well as for counteracting high impact forces, for example those encountered during loading. In some embodiments, the energy-dissipative pneumatic cushioning system includes (a) one or more support members that extend beneath at least a portion of at least one pneumatic cushioning element; (b) at least one connector assembly operable to communicatively couple the at least one pneumatic cushioning element o a gas supply unit and optionally at least one gas reservoir; and (c) at least one tethering mechanism for limiting an extent of a separation between the one or more support members and the at least one pneumatic cushioning element or a structure above the at least one pneumatic cushioning element. The at least one gas reservoir is capable of accepting at least a portion of gas from the at least one pneumatic cushioning element under a force of a load. The at least one connector assembly is further operable to allow a return of at least a portion of the gas to the at least one pneumatic cushioning element upon reduction of at least a portion of a force of the load.

The embodiments herein mitigate the effects high-impact forces on a tray and truck during loading and provide a balancing function that enhances the stability of the haul truck dump tray during loading and transport. The claimed inventions further improving the structural integrity of the haul truck dump tray by dissipating kinetic energy during loading and transport, thereby reducing the amount of energy absorbed by other components of the truck, such as the tray and chassis. This in turn results in safer operation of the haul truck.

Further, the energy-dissipative pneumatic cushioning system may help to minimize lateral movement of the haul truck dump tray, e.g., side-to-side swaying of the haul truck dump tray through increased energy dissipation compared with standard load bearing and shock absorbing mechanisms.

Certain benefits of the energy-dissipative pneumatic cushioning system over conventional shock absorbing mechanisms are realized when the heavy equipment component, such as the haul truck dump tray, is made of a light-weight material. For some lightweight materials, such as haul truck dump trays made of composite materials, large instantaneous forces, such as those experienced during loading of a haul truck in the context of mining, induce large movements in the haul truck dump tray due to the tray's lower inertia compared to a heavier steel tray. By using an energy-dissipative pneumatic cushioning system in combination with lightweight heavy equipment components having some elasticity, the energy-dissipative pneumatic cushioning system can more effectively dampen any flexing of the haul truck dump tray resulting from instantaneous high-impact loads.

In some embodiments, the one or more support members include a pair of haul truck dump tray supports positioned between a haul truck chassis and a haul truck dump tray. The pair of haul truck dump tray supports may include two longitudinal steel support beams running from front to back, and substantially parallel with one or more wheels of the haul truck. The dimensions of the two longitudinal support beams may be modified in length and width to support the large number of special purpose haul trays used in mining, transportation, and construction.

The pair of haul truck dump tray supports may include a welded steel support unit. In some embodiments, the at least one pneumatic cushioning element includes a pair of elongated pneumatic cushioning elements positioned directly over and aligned with the pair of haul truck dump tray supports and extending substantially the length of the pair of haul truck dump tray supports.

The pair of elongated pneumatic cushioning elements may include one or more elongated elastic air compartments, e.g., one or more rubber air compartments. In some embodiments, the one or more elongated elastic air compartments may have a wall thickness of from about 3 mm to about 10 mm. In some embodiments, the one or more elongated elastic air compartments have a working pressure (i.e., not under load) of up to 20 bar. In some embodiments, the pneumatic cushioning elements may be comprised of at least one of a hyperelastic material or an elastic material.

In some embodiments, the at least one connector assembly includes at least one valve and at least one flange. The at least one connector assembly may be configured to accept air from the at least one gas supply unit. The at least one gas supply unit may include at least one air compressor.

In some embodiments, the at least one gas reservoir comprises a pair of elongated air tanks that are positioned parallel to the pair of elongated pneumatic cushioning elements. In some instances, the pair of elongated air tanks may be made from a metal such as steel, from a composite material, or from polyethylene or polypropylene to reduce the weight of the energy-dissipative pneumatic cushioning system. Polyethylene or polypropylene air tanks may have a greater impact resistance and superior resistance to rust, corrosion, and fuel additives relative to other tank materials. The pair of elongated air tanks may be connected to the pair of elongated pneumatic cushioning elements via at least one conduit or connector pipe. In some embodiments, the at least one conduit or connector pipe includes at least one of a metal, polyvinylchloride, or composite material pipe. The at least one conduit or connector pipe provides enhanced durability, configurability to the geometry of the support structure, and is extremely lightweight.

The at least one conduit or connector pipe may include a valve operable to functionally separate the pair of the elongated air tanks into non-linked (i.e., independent) individual compartments. The at least one tethering mechanism may include at least one of a strap (e.g., a composite material strap), a steel link, a slotted guide pin, a chain, or a cable. The at least one tethering mechanism may be joined at a first end to at least one of the one or more support members or at least one support member cross piece, and at a second end to an attachment point of a haul truck dump tray.

In some embodiments, the one or more elongated elastic air compartments present a pair of substantially fiat upper surfaces upon which a portion of the haul truck dump tray may rest, e.g., when the one or more elongated elastic air compartments are filled to at least one working pressure. In some embodiments, the at least one working pressure is maintained passively via gas flow between the at least one pneumatic cushioning element and the at least one gas reservoir in a load-dependent manner. In other embodiments, the working pressure may be maintained actively via a pneumatic system for controlling the pressure in the at least one pneumatic cushioning element in response to sensed loads over time (e.g., via pressure regulation using valves and an air compressor). In some embodiments, the at least one pneumatic cushioning element is capable of accepting, holding, and releasing a gas on demand.

The connector assembly may be adapted to release at least a portion of gas from the pneumatic cushioning element when a pressure inside the pneumatic cushioning element reaches a threshold value. In some embodiments, the pneumatic cushioning element is capable of managing transient pressures inside the pneumatic cushioning element of up to 20 bar. A material of the at least one pneumatic cushioning element may include at least one of polyurethane, rubber, nylon, woven nylon, polypropylene, polyethylene, olefin, PVC laminated and coated fabric, cloth-backed vinyl, thermoplastic films, ethyl vinyl acetate (EVA), thermoplastic polyurethane (TPU), thermoplastic elastomers (TPE), or other material deemed suitable to those of ordinary skill in the art.

In one aspect, a haul truck comprises a chassis and a haul truck dump tray assembly. For example, a subframe of the haul truck dump tray assembly may be pivotally attached to the chassis. As described above, the haul truck further may include a pneumatic system for supplying and controlling air flow to at least one pneumatic cushioning element, and the haul truck may include a pneumatic system for supplying air to, and controlling inflation of, the at least one pneumatic cushioning element.

In some embodiments, the energy-dissipative pneumatic cushioning system is operable to dissipate at least a portion of a force of weight from a structure above the energy-dissipative pneumatic cushioning system, and/or an opposing force pushing up from the support structure beneath the pneumatic cushioning system.

The energy-dissipative pneumatic cushioning system may use polyurethane material for the air compartments, which is lightweight and effectively protects the haul truck dump tray and the one or more support members from heavy loads during loading and transport when filled with gas. The energy-dissipative pneumatic cushioning system mitigates rolling and swaying of the haul truck dump tray, thereby improving safety, durability, and efficiency during loading and transport.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1A illustrates an example view of a haul truck with an energy-dissipative pneumatic cushioning system according to some embodiments herein;

FIG. 1B illustrates a perspective view of a haul truck dump tray having the energy-dissipative pneumatic cushioning system for cushioning the haul truck dump tray and/or load in a haul truck according to some embodiments herein;

FIG. 2A illustrates a front view of the energy-dissipative pneumatic cushioning system of FIG. 1B according to some embodiments herein;

FIG. 2B illustrates an example view of a pneumatic cushioning element with a connector assembly of FIG. 2A according to some embodiments herein;

FIG. 3A illustrates a perspective view of a stabilization and tray support system of FIG. 1B according to some embodiments herein;

FIGS. 3B-3E illustrate example views of the components of the stabilization and tray support system of FIG. 1B according to some embodiments herein; and

FIGS. 4A and 4B illustrate a perspective view and a back view respectively of one or more support members of FIG. 1B according to some embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. The examples used herein are intended merely to facilitate an understanding of ways in which the claimed inventions and embodiments herein may be practiced and to further enable those of skill in the art to practice the embodiments herein and the subject matter of the claims. Accordingly, the examples should not be construed as limiting the scope of the embodiments herein or the claims of this application.

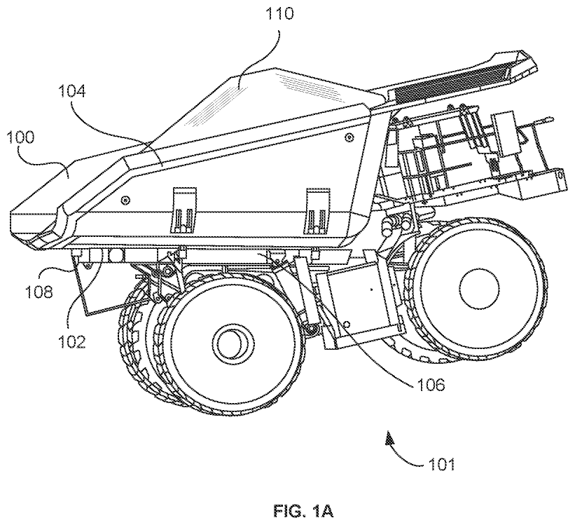

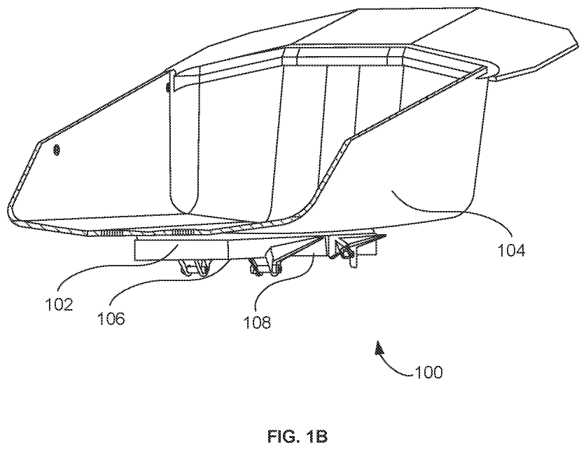

As mentioned, there remains a need for better load management in haul trucks for improved safety, structural integrity, and efficiency during loading and transportation. Referring now to the drawings, and more particularly to FIGS. 1A through 4B, where similar reference characters denote corresponding features consistently throughout the figures, preferred embodiments are shown.

FIG. 1A illustrates an example view of a haul truck 101 with an energy-dissipative pneumatic cushioning system 102 according to some embodiments herein. The haul truck 101 includes a haul truck dump tray 100, energy-dissipative pneumatic cushioning system 102, load carrying assembly 104, and stabilization and tray support system 106. Especially during loading, energy-dissipative pneumatic cushioning system 102 absorbs, mitigates, and dampens forces acting on haul dump tray, including high-impact shock impulses.

The load carrying assembly 104 may include one or more polyurethane adhesive joints in its construction for shear strength, tensile strength, energy dissipation, and/or durability. Load carrying assembly 104 may include a bed connector that connects with stabilization and tray support system 106. The bed connector may connect with stabilization and tray support system 106 using one or more bed connector assemblies. The one or more bed connector assemblies may include known mechanisms for connecting the haul truck dump tray 100 to a chassis, including any of chain links, pins, cams or other mechanism known to those of ordinary skill in the art; or components of a pivot sub-assembly, and/or a hoist portion. Cams may permit rotation of the haul truck dump tray 100 relative to a pivot point on the chassis of the haul truck 101.

FIG. 1B illustrates a perspective view of the haul truck dump tray 100 including energy-dissipative pneumatic cushioning system 102 for cushioning haul truck dump tray 100 and other components of the haul truck, according to some embodiments herein. The haul truck dump tray 100 includes energy-dissipative pneumatic cushioning system 102, load carrying assembly 104, and stabilization and tray support system 106. The load carrying assembly 104 may be formed by joining two carbon fiber laminate tray halves at the front-to-back centerline to form a whole tray structure. In some embodiments, the load carrying assembly 104 has a core that includes both high density foam and low density foam for rigidity, enclosed in a carbon fiber laminate surface. In some embodiments, the haul truck dump tray 100 includes both carbon fiber and steel components.

The load carrying assembly 104 may include a polyurethane surface coating or a wear liner that provides resistance from abrasion, and surface wear and tear. The stabilization and tray support system 106 may include one or more support members 108 as a tray support structure. The tray support structure may also include at least one location for accepting a pivot mechanism connection and at least one location for accepting a hoisting mechanism connection. In some embodiments, the tray support structure includes one or more attachment points for outriggers that are configured to provide roll stabilization support by connecting one or more attachments on a side wall of the tray with one or more attachments on the tray support structure.

The one or more support members 108 may include a pair of haul truck dump tray supports that are positioned between a chassis of the haul truck 101 and the haul truck dump tray 100. The pair of haul truck dump tray supports may include two longitudinal support beams in a front of the tray to the rear of the tray orientation, and aligned with and substantially parallel to the left side wheels and the right side wheels of the haul truck 101, e.g., the support beams may extend over a length from the front to the rear of the haul truck dump tray 100. In some embodiments, the dimensions of the two longitudinal support beams may be modified in length and width to support the large number of special purpose haul truck dump trays used in mining, transportation, and construction. The pair of haul truck dump tray supports may be made of welded steel beams. The energy-dissipative pneumatic cushioning system 102 may dissipate at least a portion of the force from the tray support structure, or the load that is above the energy-dissipative pneumatic cushioning system 102, including from any load in the tray.

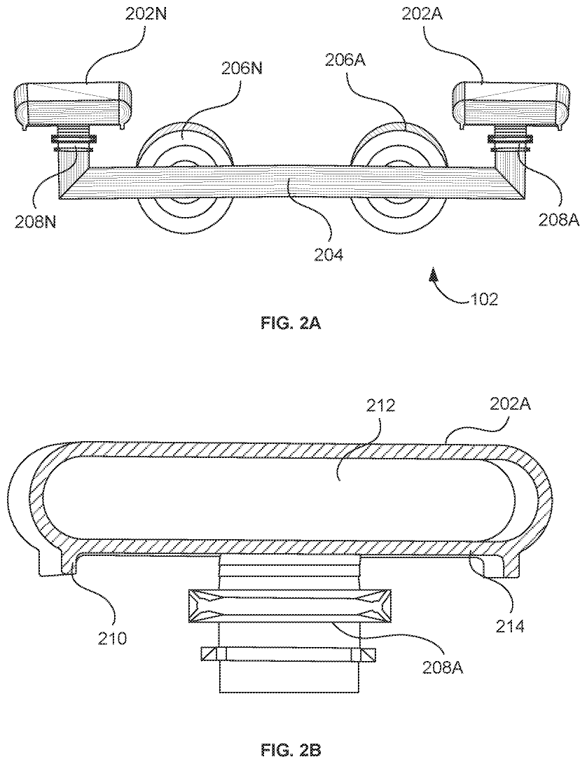

FIG. 2A illustrates a front view of the energy-dissipative pneumatic cushioning system 102 of FIG. 1B according to some embodiments herein. The energy-dissipative pneumatic cushioning system 102 includes one or more pneumatic cushioning elements 202A-N, one or more gas reservoirs 206A-N, and one or more connector assemblies 208A-N. The one or more pneumatic cushioning elements 202A-N may include an elongated air compartment. The elongated compartment may have a baseline pressure, and it may expand due to experiencing increased pressure due to gas influx from the one or more gas reservoirs 206A-N. The expansion of the elongated compartment may be primarily parallel to the longitudinal axis of the haul truck 101, or alternatively the expansion of the elongated compartment may be primarily orthogonal to the longitudinal axis of the haul truck 101. The one or more pneumatic cushioning elements 202A-N may nominally lift the haul truck dump tray 100 above the one or more support members 108 with the baseline pressure in the elongated compartment. The one or more support members 108 may include a wound carbon fiber beam. In some embodiments, the one or more pneumatic cushioning elements 202A-N are capable of accepting, holding, and releasing the gas. The one or more connector assembly may be adapted to release at least a portion of gas from the pneumatic cushioning element when a pressure inside the pneumatic cushioning elements 202A-N reaches a threshold value. For example, the one or more pneumatic cushioning elements 202A-N may manage transient pressures ranging from 5 bar to 7 bar inside the one or more pneumatic cushioning elements 202A-N.

The one or more gas reservoirs 206A-N may store air or any other suitable gas under pressure. In some embodiments, the one or more gas reservoirs 206A-N are operably connected to a gas compressor, for example an air compressor. The one or more gas reservoirs 206A-N may be associated with a gas pump for maintaining a desired pressure, e.g., maintaining a nominally high or low pressure within the pneumatic shock absorption system depending on the weight of the load on the haul truck dump tray 100. The gas reservoir may accept at least a portion of gas from the one or more pneumatic cushioning elements 202A-N under a force of a load. The one or more gas reservoirs 206A-N may include a pair of elongated air tanks that are positioned parallel to the pair of elongated pneumatic cushioning elements. The pair of elongated air tanks may be made from polyethylene or polypropylene.

The one or more connector assemblies 208A-N are operable to communicatively couple the one or more pneumatic cushioning elements 202A-N and the one or more gas reservoirs 206A-N. The one or more connector assemblies 208A-N may allow a return of at least a portion of gas to the one or more pneumatic cushioning elements 202A-N on reduction of at least a portion of the force of the load on pneumatic cushioning elements 202A-N. The one or more connector assemblies 208A-N may be communicatively coupled to the one or more pneumatic cushioning elements 202A-N and the one or more gas reservoirs 206A-N. In some embodiments, the one or more connector assemblies 208A-N includes at least one valve and at least one flange. The one or more connector assemblies 208A-N may accept air from the one or more gas reservoirs 206A-N. The one or more connector assemblies 208A-N may also be configured to accept air from the gas supply unit. In some embodiments, the one or more gas reservoirs 206A-N is itself a gas supply unit. The gas supply unit may include at least one air compressor. The pair of elongated air tanks may be connected to the pair of elongated pneumatic cushioning elements via the one or more connector assemblies 208A-N. In some embodiments, the one or more connector assemblies 208A-N includes at least one conduit or connector pipe 204. The pair of elongated air tanks may be connected to the pair of elongated pneumatic cushioning elements via the at least one conduit or connector pipe 204. For example, the at least one conduit or connector pipe 204 may include a polyethylene pipe, a polypropylene pipe, or a polyvinylchloride pipe. In some embodiments, the at least one conduit or connector pipe 204 includes a valve that is operable to functionally separate the pair of elongated air tanks into non-linked individual (i.e., independent) compartments.

During loading of a tray, high-impact forces are common, placing extreme physical stresses on haul truck dump tray 100, the one or more support members 108, and/or the chassis of haul truck 101. Accordingly, energy-dissipative pneumatic cushioning system 102 that is filled with gas may absorb a portion of the energy of the high-impact forces via compression of gas and a concomitant increase in pressure within the one or more pneumatic cushioning elements 202A-N, and/or via release of gas into the one or more gas reservoirs 206A-N. In some embodiments, the energy-dissipative pneumatic cushioning system 102 is designed to maintain a dynamic equilibrium in which the one or more pneumatic cushioning elements 202A-N are kept at a substantially constant working pressure so that there is a capacity for additional gas compression and cushioning. Increased weight on the energy-dissipative pneumatic cushioning system 102, e.g., during loading of the haul truck dump tray 100, may supply a baseline net increasing force that increases the baseline pressure within the elongated compartment of the one or more pneumatic cushioning elements 202A-N. This increased pressure may be regulated by release of gas into the one or more gas reservoirs 206A-N.

The one or more connector assemblies 208A-N may release the excess pressure from the one or more pneumatic cushioning elements 202A-N to the one or more reservoirs 206A-N. The one or more gas reservoirs 206A-N may accept at least a portion of the gas from the one or more pneumatic cushioning elements 202A-N under the force of a load on the haul truck dump tray 100. In some embodiments, the one or more connector assemblies 208A-N reduce pressure in pneumatic cushioning elements 202A-N via release of gas when elevated pressure in the one or more pneumatic cushioning elements 202A-N exceeds the baseline pressure of the one or more pneumatic cushioning elements 202A-N. In some embodiments, the one or more connector assemblies 208A-N reduce pressure in the one or more pneumatic cushioning elements 202A-N via release of gas when elevated pressure in the one or more pneumatic cushioning elements 202A-N exceeds a threshold pressure of the one or more pneumatic cushioning elements 202A-N.

When gas from the one or more pneumatic cushioning elements 202A-N is released, any rebounding force of the one or more pneumatic cushioning elements 202A-N may be dampened and the haul truck dump tray 100 may settle stably on the one or more support members 108. In some embodiments, sequential increases in pressure within the one or more pneumatic cushioning elements 202A-N may trigger the one or more connector assemblies 208A-N to release gas into the one or more gas reservoirs 206A-N and thereby reduce the excess pressure from the haul truck dump tray 100 and, e.g., act to dissipate at least a portion of the energy of the impact of loading on the haul truck dump tray 100, the one or more support members 108, the chassis, and other components of the haul truck 101.

In some embodiments, the energy-dissipative pneumatic cushioning system 102 includes a pressure-regulating flange that maintains a working pressure within the elongated compartment of the one or more pneumatic cushioning elements 202A-N. The one or more pneumatic cushioning elements 202A-N may include a pair of elongated pneumatic cushioning elements that are positioned directly over a pair of haul truck dump tray supports, the pair of elongated pneumatic cushioning elements extending substantially the entire length of the pair of haul truck dump tray support members 108 and aligned with them. The pair of elongated pneumatic cushioning elements may include one or more elongated elastic air compartments. The pair of elongated elastic air compartments may have a wall thickness of from about 3 mm to about 10 mm. The pair of elongated elastic air compartments may include a working pressure (i.e., not under load) of up to 20 bar. The pair of elongated elastic air compartments may present a pair of substantially flat upper surfaces upon which a portion of the haul truck dump tray 100 rests when the pair of elongated elastic air compartments are filled to at least one working pressure. In some embodiments, the working pressure is maintained passively via gas flow between the one or more pneumatic cushioning elements 202A-N and the one or more gas reservoirs 206A-N in a load-dependent manner. The working pressure may be maintained actively via the pneumatic system for controlling the pressure in the one or more pneumatic cushioning elements 202A-N in response to the sensed loads over time (e.g., via pressure regulation using valves and an air compressor).

The energy-dissipative pneumatic cushioning system 102 may include at least one tethering mechanism for limiting an extent of a separation between the one or more support members 108 and the one or more pneumatic cushioning elements 202A-N or the tray support structure above the one or more pneumatic cushioning elements 202A-N. The at least one tethering mechanism may include any of a strap (e.g., a composite material strap), a steel link, a slotted guide pin, a chain, and/or a cable.

FIG. 2B illustrates an example view of a pneumatic cushioning element 202A with a connector assembly 208A of FIG. 2A according to some embodiments herein. The pneumatic cushioning element 202A includes a pneumatic bag cover 210, a pneumatic bag void 212, and a dog ear 214. In some embodiments, the pneumatic bag void 212 is an elongated compartment. The dog ear 214 may accept the wound carbon fiber beam for the placement of the pneumatic cushioning element 202A. The bottom of the elongated compartment may be placed on the top of the one or more support members 108 (e.g., a wound carbon fiber beam) and the haul truck dump tray 100 may be placed directly on top of the elongated compartment of the pneumatic cushioning element 202A. In some embodiments, the connector assembly 208A selectively and reversibly seals a pathway from a gas reservoir (e.g., a gas reservoir 206A) to the elongated compartment of the pneumatic cushioning element 202A. A material of the pneumatic cushioning element 202A may include any of polyurethane, rubber, nylon, woven nylon, polypropylene, polyethylene, olefin, PVC laminated and coated fabric, cloth-backed vinyl, thermoplastic films, ethyl vinyl acetate (EVA), thermoplastic polyurethane (TPU), or thermoplastic elastomers (TPE), or other appropriate material known to those of ordinary skill in the art.

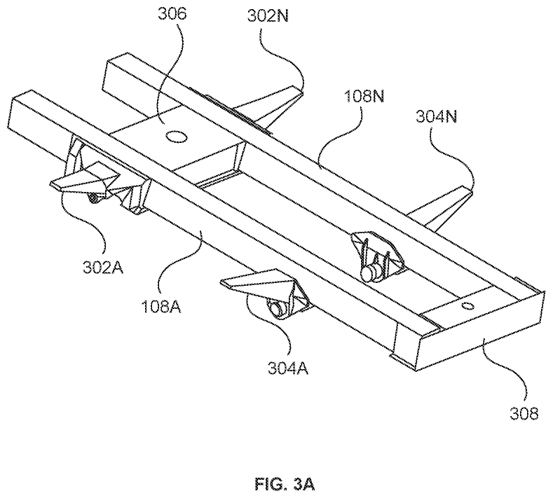

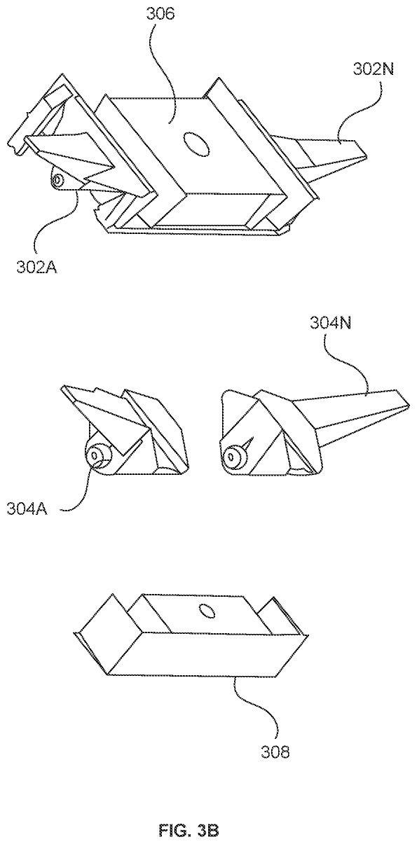

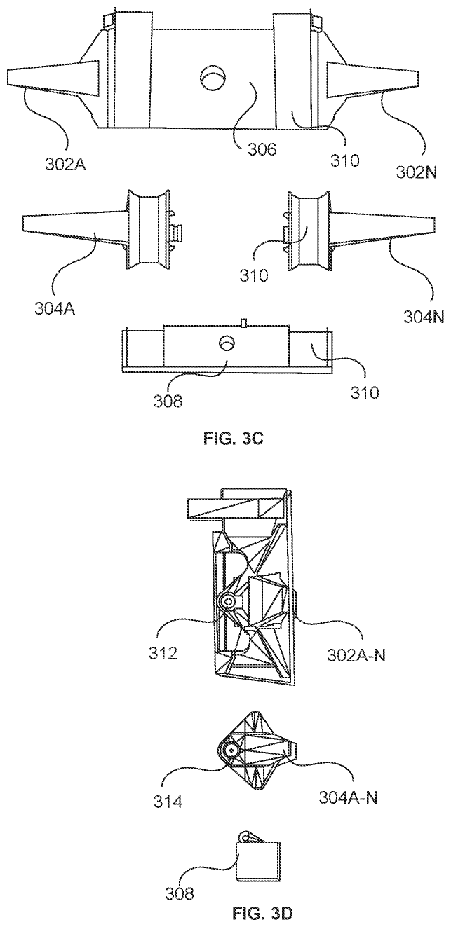

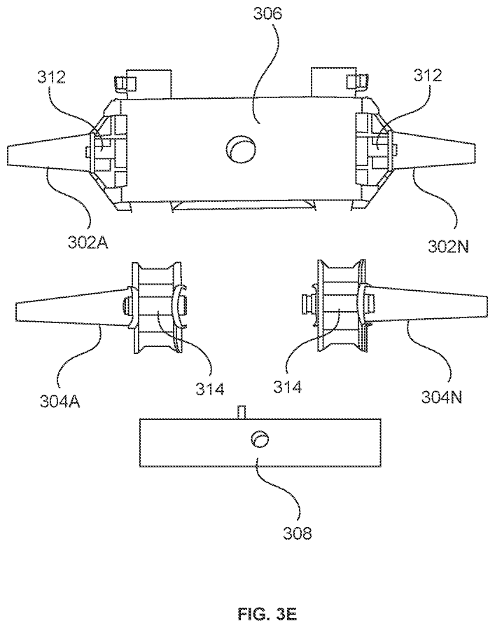

FIG. 3A illustrates a perspective view of the stabilization and tray support system 106 of FIG. 1B according to some embodiments herein. The stabilization and tray support system 106 includes one or more support members 108A-N, one or more forward outriggers 302A-N, one or more rear outriggers 304A-N, a torque box 306 and a rear frame assembly 308. In some embodiments, the one or more support members 108A-N extend beneath at least a portion of the one or more pneumatic cushioning elements 202A-N. For example, the one or more support members 108A-N may include steel support beams or a welded steel support structure.

The one or more forward outriggers 302A-N and the one or more rear outriggers 304A-N provide roll stabilization support in the haul truck dump tray 100 by securing one or more points on the haul truck dump tray 100 to one or more points on the one or more support members 108A-N or chassis. The torque box 306 may include a hole that accepts at least one tethering mechanism for limiting the extent of the separation between the one or more support members 108A-N and the one or more pneumatic cushioning elements 202A-N or the tray support structure above the one or more pneumatic cushioning elements 202A-N. The rear frame assembly 308 also may include a hole that accepts at least one tethering mechanism for limiting the extent of separation between the one or more support members 108A-N and the one or more pneumatic cushioning elements 202A-N or the tray support structure above the one or more pneumatic cushioning elements 202A-N. In some embodiments, the one or more forward outriggers 302A-N and the one or more rear outriggers 304A-N may stabilize the side-to-side or lateral motion of the haul truck dump tray 100 via a connection between attachment points on the tray side walls and attachment points on, e.g., the support members 108A-N.

For example, during loading of the haul truck dump tray 100 or during transport, forces may push on one or more of the side walls of the haul truck dump tray 100, causing the haul truck dump tray 100 to tip laterally. In order to prevent the haul truck dump tray 100 from tipping over, the one or more forward outriggers 302A-N and the one or more rear outriggers 304A-N may anchor sides of the haul truck dump tray 100 to an out carriage or other point on a haul truck support structure (e.g., one or more support members 108A-N or the chassis), thereby providing an opposing force for stability. In some embodiments, the one or more forward outriggers 302A-N and the one or more rear outriggers 304A-N stabilize the haul truck dump tray 100 during uneven loading, which may favour one side of the haul truck dump tray 100 over the other side. The one or more forward outriggers 302A-N and the one or more rear outriggers 304A-N may also provide an opposing force for stability while hauling.

In some embodiments, the at least one tethering mechanism may include any of a strap (e.g., a composite material strap), a steel link, a slotted guide pin, a chain, and/or a cable. The at least one tethering mechanism may be joined at a first end to at least one of the one or more support members 108A-N or at least one support member cross piece, and at a second end to an attachment point of a haul truck dump tray 100.

FIGS. 3B-3E illustrate example views of the components of the stabilization and tray support system 106 of FIG. 1B according to some embodiments herein. FIG. 3B illustrates a perspective view of the one or more forward outriggers 302A-N, the one or more rear outriggers 304A-N, the torque box 306, and the rear frame assembly 308. The functions and operations of the components are as explained above. FIG. 3C illustrates a top view of the one or more forward outriggers 302A-N, the one or more rear outriggers 304A-N, the torque box 306, and the rear frame assembly 308. The one or more forward outriggers 302A-N and the torque box 306 may include a channel 310 for accepting the one or more support members 108A-N. In some embodiments, the one or more support members 108A-N may include steel support beams. FIGS. 3D and 3E illustrate a side view and a bottom view respectively of the one or more forward outriggers 302A-N, the one or more rear outriggers 304A-N, the torque box 306 and the rear frame assembly 308. The one or more forward outriggers 302A-N may include a hydraulic mount 312 for attaching the haul truck dump tray 100 to a point on the chassis of the haul truck 101. The hydraulic mount 312 may attach the haul truck dump tray 100 pivotally to the chassis of the haul truck 101.

The one or more rear outriggers 304A-N may include a chassis tray mount 314 for attaching the haul truck dump tray 100 to the chassis of the haul truck 101. In some embodiments, the chassis tray mount 314 is a pivot location for attaching the haul truck dump tray 100 to the chassis the haul truck 101. The one or more rear outriggers 304A-N may include a subframe of the haul truck dump tray 100 that is pivotally attached to the chassis of the haul truck 101. In some embodiments, the haul truck 101 includes a pneumatic system for supplying and controlling airflow to the one or more pneumatic cushioning elements 202A-N. The pneumatic system on the haul truck 101 may supply air to the one or more pneumatic cushioning elements 202A-N and control inflation and/or deflation of the one or more pneumatic cushioning elements 202A-N.

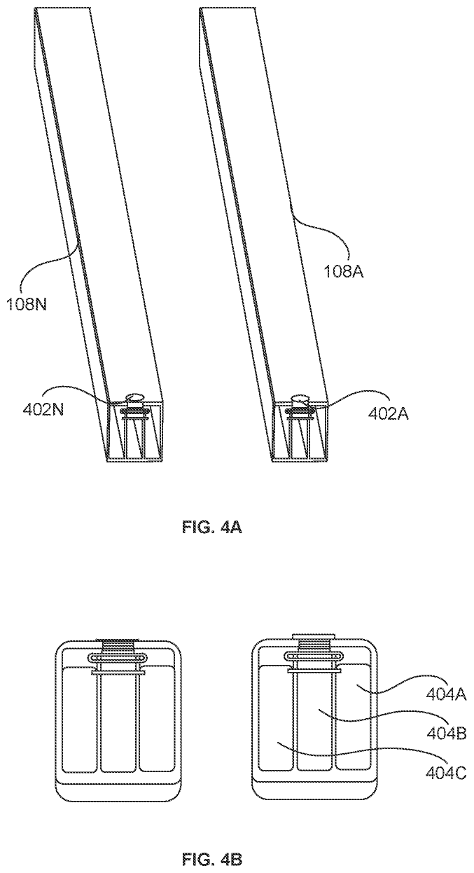

FIGS. 4A and 4B illustrate a perspective view and a back view respectively of the one or more support members 108A-N of FIG. 1B according to some embodiments herein. The one or more support members 108A-N includes one or more plumbing elements 402A-N for cushioning the haul truck dump tray 100. In some embodiments, the one or more plumbing elements 402A-N are a plumbing location for gas conduits associated with an elongated compartment of the one or more pneumatic cushioning elements 202A-N. In some embodiments, the one or more support members 108A-N may include steel support beams. The one or more support members 108A-N may include one or more structural chambers 404A-C. In some embodiments, the one or more structural chambers 404A-N may include any of a first structural chamber 404A, a second structural chamber 404B, and/or a third structural chamber 404C.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the appended claims.

We claim:

1. An energy-dissipative pneumatic cushioning system comprising:
one or more support members extending beneath at least a portion of an at least one pneumatic cushioning element;
at least one connector assembly operable to communicatively couple the at least one pneumatic cushioning element to a gas supply unit, and wherein the at least one connector assembly is further operable to allow a return of at least a portion of the gas to the at least one pneumatic cushioning element upon reduction of at least a portion of a force of the load; and
at least one tethering mechanism for limiting an extent of a separation between the one or more support members and the at least one pneumatic cushioning element or a structure above the at least one pneumatic cushioning element.

2. The energy-dissipative pneumatic cushioning system of claim 1, wherein the one or snore support members are steel support members.

3. The energy-dissipative pneumatic cushioning system of claim 2, wherein the pair of haul truck dump tray supports comprise two longitudinal steel support beams welded to at least two steel cross members to form a steel support unit that extends over a length corresponding to a distance from the front to the rear of the haul truck dump tray.

4. The energy-dissipative pneumatic cushioning system of claim 2, wherein the one or more steel support members comprise a welded steel support structure.

5. The energy-dissipative pneumatic cushioning system of claim 2, wherein the at least one pneumatic cushioning element comprises a pair of elongated pneumatic cushioning elements positioned directly over the pair of haul truck dump tray supports and extending substantially the entire length of the pair of haul truck dump tray supports.

6. The energy-dissipative pneumatic cushioning system of claim 5, wherein the pair of elongated pneumatic cushioning elements comprises a pair of elongated elastic air compartments.

7. The energy-dissipative pneumatic cushioning system of claim 6, wherein the elongated elastic air compartments have a wall thickness of from about 3 mm to about 10 mm.

8. The energy-dissipative pneumatic cushioning system of claim 6, wherein the pair of elongated elastic air compartments has a working pressure of up to 20 bar.

9. The energy-dissipative pneumatic cushioning system of claim 1, wherein the at least one connector assembly comprises at least one valve and at least one flange.

10. The energy-dissipative pneumatic cushioning system of claim 1, wherein the at least one connector assembly is configured to accept air from the at least one gas supply unit.

11. The energy-dissipative pneumatic cushioning system of claim 10, wherein the at least one gas supply unit comprises at least one air compressor.

12. The energy-dissipative pneumatic cushioning system of claim 5, further comprising an at least one gas reservoir, wherein the at least one gas reservoir comprises a pair of elongated air tanks, and wherein the at least one gas reservoir is capable of accepting at least a portion of gas from the at least one pneumatic cushioning element under a force of a load.

13. The enemy-dissipative pneumatic cushioning system of claim 12, wherein the pair of elongated air tanks comprises a pair of one or more of a metal or composite material air tank.

14. The energy-dissipative pneumatic cushioning system of claim 12, wherein the pair of elongated air tanks is connected to the pair of elongated pneumatic cushioning elements via at least one connector pipe.

15. The energy-dissipative pneumatic cushioning system of claim 14, wherein the at least one connector pipe comprises at least one of a metal, polyvinylchloride, or composite material pipe.

16. The energy-dissipative pneumatic cushioning system of claim 14, wherein the at least one connector pipe comprises a valve operable to functionally separate the pair of elongated air tanks into non-linked individual compartments.

17. The energy-dissipative pneumatic cushioning system of claim 1, wherein the at least one tethering mechanism comprises at least one of a strap, a steel link, a slotted guide pin, a chain, or a cable.

18. The energy-dissipative pneumatic cushioning system of claim 1, wherein the at least one tethering mechanism is joined at a first end to at least one of the one or more support members or at least one support member cross piece, and at a second end to an attachment point of a haul truck dump tray.

19. The energy-dissipative pneumatic cushioning system of claim 6, wherein the pair of elongated elastic air compartments presents a pair of substantially flat upper surfaces upon which the haul truck dump tray may rest when the pair of elongated elastic air compartments are filled to at least one working pressure.

20. The energy-dissipative pneumatic cushioning system of claim 12, wherein a working pressure is maintained passively via gas flow between the at least one pneumatic cushioning element and the at least one gas reservoir in a load-dependent manner.

21. The energy-dissipative pneumatic cushioning system of claim 1, wherein a working pressure is maintained actively via a pneumatic system for controlling pressure in the at least one pneumatic cushioning element in response to sensed loads over time. The energy-dissipative pneumatic cushioning system of claim 1, wherein the at least one pneumatic cushioning element is capable of accepting, holding, and releasing a gas.

23. The energy-dissipative pneumatic cushioning system of claim 22, wherein the at least one connector assembly is adapted to release at least a portion of gas from the pneumatic cushioning element when a pressure inside the pneumatic cushioning element reaches a threshold value.

24. The energy-dissipative pneumatic cushioning system of claim 22, wherein the pneumatic cushioning element is capable of managing transient pressures inside the pneumatic cushioning element of up to 20 bar.

25. The energy-dissipative pneumatic cushioning system of clam 1, wherein the at least one pneumatic cushioning element is comprised of at least one of polyurethane, rubber, nylon, woven nylon, PVC laminated and coated fabric, cloth-backed vinyl, thermoplastic films, ethyl vinyl acetate (EVA), thermoplastic polyurethane (TPU), or thermoplastic elastomers (TPE).

26. The energy-dissipative pneumatic cushioning system of claim 1, wherein a subframe of a haul truck dump tray assembly is pivotally attached to a chassis of a haul truck; the haul truck comprising a pneumatic system for supplying and controlling air flow to the at least one pneumatic cushioning element.

27. A haul truck comprising a chassis and a haul truck dump tray assembly, wherein a subframe of the haul truck dump tray assembly is pivotally attached to a chassis; the haul truck further comprising a pneumatic system for supplying air to, and controlling inflation of, the at least one pneumatic cushioning element.

28. The energy-dissipative pneumatic cushioning system of claim 1, wherein the energy-dissipative pneumatic cushioning system is operable to dissipate at least a portion of a force of weight from a structure above the energy-dissipative pneumatic cushioning system.
